(19) United States
(12) Patent Application Publication
(10) Pub. No.: US 2007/0181327 A1
(43) Pub. Date: Aug. 9, 2007

(54) PORTABLE ELECTRONIC DEVICE

(75) Inventors: Arthur Chang, Taipei (TW); Fu-Ming Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/617,736

(22) Filed: Dec. 29, 2006

(30) Foreign Application Priority Data
Feb. 7, 2006 (TW) 95104016

(51) Int. Cl. H02G 3/08

(52) U.S. Cl. 174/50

(57) ABSTRACT

A portable electronic device including a first casing, a second casing, and a fixing element is provided. The first casing has an indentation, and the indentation has a bottom wall and at least one side wall, wherein the side wall is connected to the bottom wall. The bottom wall has a through hole, and the side wall has at least one air vent. The second casing has a fixing portion, and the fixing element has a first portion, wherein the first portion is pivoted in the through hole and connected to the fixing portion.

### CROSS-REFERENCE TO RELATED APPLICATION

This application claims the priority benefit of Taiwan application serial no. 95104016, filed Feb. 7, 2006. All disclosure of the Taiwan application is incorporated herein by reference.

### BACKGROUND OF THE INVENTION

1. Field of the Invention

The present invention relates to a portable electronic device. More particularly, the present invention relates to a portable electronic device having air vents on the casing assembly structure thereof.

2. Description of the Related Art

Recently, along with the rapid development of technologies, the volumes of portable electronic devices are getting lighter and smaller according to user's requirements. As to a typical portable electronic device, such as a notebook computer, a MP3 flash disk, or a smart phone, electronic elements of many different functions are disposed within a limited volume so as to make the portable electronic device multifunctional. Generally, most portable electronic devices use two casings to construct a containing space for accommodating and protecting the circuit board of the portable electronic device and the electronic elements on the circuit board.

FIG. 1A is a partial cross-sectional view of a conventional portable electronic device, and FIG. 1B is a partial diagram of the top casing in FIG. 1A along line A-A. Referring to FIG. 1A and FIG. 1B, a top casing 110 and a bottom casing 120 of the portable electronic device 100 are fixed by a screw 130. To bury the head of the screw 130 into the top casing 110, the top casing 110 has an indentation 112, so that the screw 130 can pass through the indentation 112 to be locked to the bottom casing 120, and the head of the screw 130 is buried into the indentation 112 and does not protrude from the external surface of top casing 110.

Besides, since the electronic element (not shown) in the portable electronic device 100 is the largest heat source during the operation of the portable electronic device 100, the electronic element may get damaged if the heat generated by the electronic element is not removed, the portable electronic device 100 may not work properly due to high temperature. One proper approach for heat dissipation so as to reduce the working temperature in the portable electronic device 100 by disposing a plurality of cooling holes 114 on the top casing 110 (or the bottom casing 120) of the portable electronic device 100 for ventilating the hot air out of the portable electronic device 100 through the cooling holes 114, and also for allowing the cool air outside of the portable electronic device 100 to enter the portable electronic device 100 through the cooling holes 114 (or other convection holes), so as to lower the temperature inside the portable electronic device 100. As described above, the conventional portable electronic device 100 uses only the cooling holes 114 for heat dissipation without the assistance of a proactive cooling system.

### SUMMARY OF THE INVENTION

Accordingly, the present invention is directed to a portable electronic device having air vents on the casing assembly structure thereof for heat dissipation.

To achieve the aforementioned and other objectives, a portable electronic device including a first casing, a second casing, and a fixing element is provided. The first casing has an indentation, and the indentation has a bottom wall and at least one side wall, wherein the side wall is connected to the bottom wall, the bottom wall has a through hole, and the side wall has at least one air vent. The second casing has a fixing portion, the fixing element has a first portion, and the first portion is pivoted in the through hole and connected to the fixing portion.

In an embodiment of the present invention, the aforementioned fixing element further has a second portion which is in contact with the bottom wall.

In an embodiment of the present invention, the aforementioned fixing element is a screw, the first portion is a stud, and the second portion is a stud head.

In an embodiment of the present invention, the aforementioned fixing portion has a screw hole, and the first portion is connected to the screw hole.

In an embodiment of the present invention, the aforementioned portable electronic device further includes a circuit board which is covered by the first casing and the second casing.

According to the present invention, the indentation on the casing of the portable electronic device has air vents for heat dissipation of the portable electronic device, thus, the portable electronic device has good heat dissipating effect.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a conventional portable electronic device.

FIG. 1B is a diagram of the top casing in FIG. 1A along line A-A.

FIG. 2A is a cross-sectional view of a portable electronic device according to an embodiment of the present invention.

FIG. 2B is a diagram of the first casing in FIG. 2A along line B-B.

FIG. 3 is a diagram of a portable electronic device according to another embodiment of the present invention.

### DESCRIPTION OF EMBODIMENTS

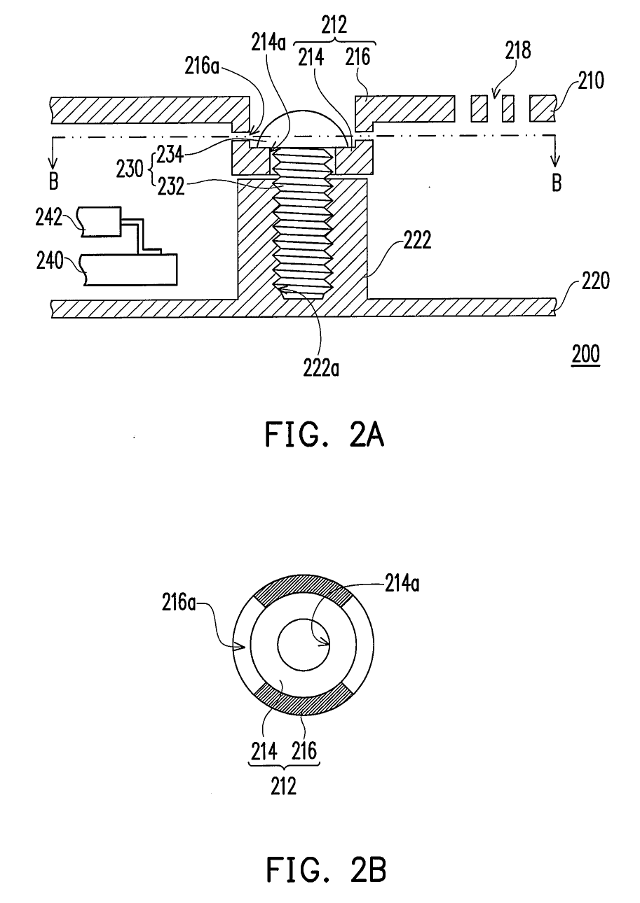

FIG. 2A is a cross-sectional view of a portable electronic device according to an embodiment of the present invention, and FIG. 2B is a diagram of the first casing in FIG. 2A along line B-B. Referring to both FIG. 2A and FIG. 2B, in the present embodiment, the portable electronic device 200 may be a notebook computer or other portable electronic device which requires heat dissipation. The portable electronic device 200 includes a first casing 210, a second casing 220, and a fixing element 230. The first casing 210 has an indentation 212, and the indentation 212 includes a bottom wall 214 and at least one side wall 216, wherein the side wall 216 is connected to the bottom wall 214. In the present embodiment, the side wall 216 of the portable electronic device 200 is approximately vertical to the bottom wall 214. The bottom wall 214 has a through hole 214a, which is suitable for the fixing element 230 to pivot through therein. It should be noted that the side wall 216 has at least one air vent 216a. Thus, the air inside the portable electronic device 200 can be ventilated out of the portable electronic device 200 through the air vent 216a, and the air outside the portable electronic device 200 can enter the portable electronic device 200 through the air vent 216a.

As described above, the second casing 220 has a fixing portion 222, and the fixing element 230 has a first portion 232, wherein the first portion 232 of the fixing element 230 is pivoted in the through hole 214a and connected to the fixing portion 222. Besides, the fixing element 230 further has a second portion 234 which covers the through hole 214a but does not cover the air vent 216a, and the second portion 234 is in contact with the bottom wall 214. In other words, the first casing 210 is fixed on the second casing 220 by using the fixing element 230.

In the present embodiment, the fixing element 230 is a screw, thus, the first portion 232 is a stud, and the second portion 234 is a stud head. To connect the fixing element 230 (the screw) to the fixing portion 222, the fixing portion 222 has a screw hole 222a, so that the first portion 232 can be connected into the screw hole 222a. Besides, the portable electronic device 200 further includes a circuit board 240 which is covered by the first casing 210 and the second casing 220, and the electronic element 242 that will become the heat source of the portable electronic device 200 during its operation is installed on the circuit board 240.

Referring to FIG. 2A again, while the electronic element 242 is in operation, the temperature thereof increases along with the operating time, thus, the heat of the electronic element 242 is conducted into the cooler air around the electronic element 242 so that the temperature thereof is increased. The operating temperature of the electronic element 242 will be too high if the heat of the electronic element 242 is not removed, which may cause damage to the electronic element 242. In the present embodiment, the heat produced by the electronic element 242 on the circuit board 240 can be ventilated out of the portable electronic device 200 through the air vent 216a in the manner of free convection or forced convection, so that the electronic element 242 can work continuously under a normal operating temperature.

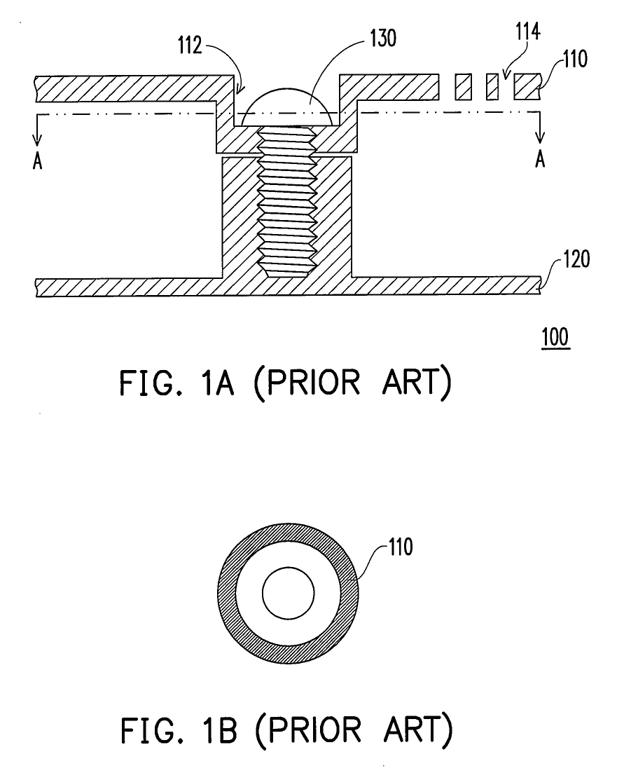

It should be noted that in the portable electronic device 200 of the present invention, besides the at least one air vent 216a on the indentation 212 of the first casing 210, the first casing 210 may further include a plurality of convection holes 218, which are similar to the conventional cooling holes 114 in FIG. 1A. Thus, the hot air in the portable electronic device 200 can be ventilated through the convection holes 218 and the air vent 216a. Compared to conventional portable electronic devices, the portable electronic device 200 in the present invention has better heat dissipating effect for it uses the air vent 216a for heat dissipation.

In particular, the assembly of the portable electronic device 200 generally requires a plurality of fixing elements 230 and the formation of a plurality of corresponding indentations 212 on the first casing 210, thus, air vents 216a can be formed on the side walls 216 of the indentations 212 so as to ventilate the hot air in the portable electronic device 200 out more quickly.

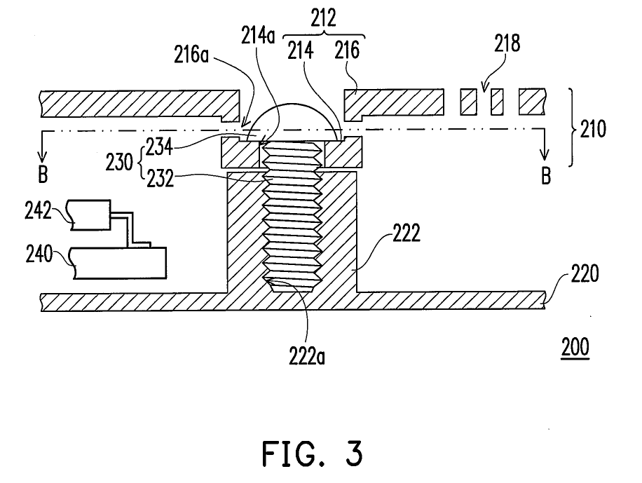

Moreover, to allow the portable electronic device 200 to have further better heat dissipation effect, the cross-sectional area of the air current passing through the air vents 216a can be increased to ventilate the hot air in the portable electronic device 200 more quickly without affecting the structure of the first casing 210 of the portable electronic device 200, as shown in FIG. 3.

In overview, according to the preferred embodiments of the present invention, the air vents are disposed on the indentations of the portable electronic device, thus the hot air in the portable electronic device can be ventilated out of the portable electronic device through the air vents. Compared to conventional portable electronic devices, the portable electronic device in the present invention has better heat dissipating effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic device, comprising:
a first casing, having an indentation, the indentation including a bottom wall and at least one side wall, the side wall being connected to the bottom wall, the bottom wall having a through hole, the side wall having at least one air vent;
a second casing, having a fixing portion; and
a fixing element, having a first portion being pivoted in the through hole and connected to the fixing portion.

2. The portable electronic device as claimed in claim 1, wherein the fixing element further has a second portion which is in contact with the bottom wall.

3. The portable electronic device as claimed in claim 2, wherein the second portion covers the through hole.

4. The portable electronic device as claimed in claim 2, wherein the fixing element is a screw, the first portion is a stud, and the second portion is a stud head.

5. The portable electronic device as claimed in claim 1, wherein the fixing portion has a screw hole, and the first portion is connected to the screw hole.

6. The portable electronic device as claimed in claim 1, further comprising a circuit board covered by the first casing and the second casing.
